(19) United States
(12) Patent Application Publication
(10) Pub. No.: US 2023/0373029 A1
(43) Pub. Date: Nov. 23, 2023

(54) LASER WELDING JOINT AND LASER WELDING METHOD

(71) Applicant: NHK SPRING CO., LTD., Yokohama-shi (JP)

(72) Inventor: Yuichi TAKAYANAGI, Yokohama-shi (JP)

(21) Appl. No.: 18/317,461

(22) Filed: May 15, 2023

(30) Foreign Application Priority Data
May 17, 2022 (JP) 2022-081088

(51) Int. Cl. B23K 26/244; B23K 26/082

(52) U.S. Cl. CPC B23K 26/244; B23K 26/082; B23K 2101/18

(57) ABSTRACT

A laser welding joint S1 includes a first bead 10 formed along a first path R1 and a second bead 20 formed along a second path R2. The second bead 20 is formed such that a side portion 20S of the second bead 20 overlaps with a finishing end region 10A of the first bead 10. A starting point of the second path R2 is a position different to a finishing point of the first path R1.

### CROSS-REFERENCE TO RELATED APPLICATION

This application claims priority under 35 USC 119 from Japanese Patent application No. 2022-081088 filed on May 17, 2022, the disclosure of which is incorporated by reference herein in its entirety.

### TECHNICAL FIELD

The present invention relates to a laser welding joint and a laser welding method.

### BACKGROUND ART

In a laser welding method is disclosed in Japanese Patent Application Laid-Open (JP-A) No. 2012-135794, in order to reduce indentation at a finishing end region of a weld bead, at a finishing end of laser scanning in a forward direction across a specific segment the scanning direction is reversed, and then laser scanning is performed in the reverse direction while displaced, so that the laser scanning in the forward direction and a portion of the weld bead overlap with each other.

### SUMMARY OF INVENTION

### Technical Problem

In the above method, the irradiation time at the finishing end is liable to be prolonged as a result of turning back at the finishing end of the forward direction laser scanning. This results in heat input becoming greater at the finishing end, with a concern that this might cause excessive melting of the base metal, leading an indentation in the weld bead developing.

In consideration of the above circumstances, an object of the present invention is to provide a laser welding joint and a laser welding method in which indentation at a finishing end region of a weld bead is prevented from occurring.

### Solution to Problem

A laser welding joint of a first aspect includes a first bead formed along a first path and a second bead formed along a second path. In the second bead a side portion or a start end portion of the second bead is formed so as to overlap with a finishing end region of the first bead, and a starting point of the second path is at a position different to a finishing point of the first path.

In this aspect the laser welding joint includes the first bead formed along the first path and the second bead formed along the second path.

The second bead is formed such that the side portion or the start end portion of the second bead overlaps with the finishing end region of the first bead. Molten metal from laser irradiation has the property of flowing in a reverse direction to the scanning direction and perpendicular directions thereto, and so an indentation formed in a finishing end region of the first bead can be filled with molten metal flowing in the process of forming the second bead (the second irradiation process) due to forming the second bead in this manner.

The starting point of the second path is at a position different to the finishing point of the first path. Namely, laser irradiation is temporarily stopped at the finishing point of the first path, and laser irradiation is restarted from a different position to the finishing point of the first path (at the starting point of the second path), with this enabling excessive heat input due to turning back to be suppressed, thereby enabling an indentation to be suppressed from developing.

A laser welding joint of the second aspect is the first aspect, wherein the second bead extends in a direction substantially perpendicular to the finishing end region of the first bead, and the start end portion of the second bead overlaps with the finishing end region of the first bead.

In this aspect the second bead extends in the direction substantially perpendicular to the finishing end region of the first bead. The start end portion of the second bead overlaps with the finishing end region of the first bead.

The direction in which molten metal flows is mainly a reverse direction to the scanning direction, and so this aspect enables effective hole filling to be performed.

Note that reference here to substantially perpendicular means a range of 90°±10°.

A laser welding joint of a third aspect is the first aspect, wherein the second bead extends in a direction substantially parallel to the finishing end region of the first bead, and the side portion of the second bead overlaps with the finishing end region of the first bead.

In this aspect the second bead extends in the direction substantially parallel to the finishing end region of the first bead. The side portion of the second bead overlaps with the finishing end region of the first bead.

Due to molten metal also flowing in a direction perpendicular to the scanning direction, this aspect is also able to perform hole filling.

Note that reference here to substantially parallel means a range of 0°±10°.

A laser welding joint of a fourth aspect is the third aspect, wherein the scanning direction of the second path is a direction toward a side of the finishing point of the first path.

In this aspect the scanning direction of the second path is the direction toward the first path finishing point side. This thereby enables a more even heat input state at the overlapping portion between the first path and the second path than in an embodiment in which the scanning direction of the second path is a direction toward a side of the starting point of the first path, thereby enabling control so as to achieve the same weld cross-section at the overlapping portion.

A laser welding joint of a fifth aspect is any one of the first aspect to the fourth aspect, wherein the second bead is formed under conditions in which only an upper sheet is melted and a lower sheet is not melted.

In this aspect the second bead is formed under conditions in which only the upper sheet is melted and the lower sheet is not melted. This accordingly enables burn-through or the like arising from the laser irradiation to form the second bead to be prevented from occurring.

A laser welding method of a sixth aspect includes a first irradiation process in which a laser is irradiated along a first path to form a first bead, a movement process in which a laser sight is moved from a finishing point of the first path to a starting point of a second path without laser irradiation, and a second irradiation process in which a laser is irradiated along the second path to form a second bead, wherein the second irradiation process is performed such that molten metal from the second irradiation process flows toward a finishing end region of the first bead.

The laser welding method of this aspect enables the laser welding joint of the first aspect to be fabricated.

As described above, the laser welding joint and the laser welding method according to the present invention prevents indentation at a finishing end region of a weld bead.

### BRIEF DESCRIPTION OF DRAWINGS

Exemplary embodiments of the present disclosure will be described in detail based on the following figures, wherein:

FIG. 1 is a plan view illustrating a laser welding joint of a first exemplary embodiment:

FIG. 2 is a plan view illustrating a laser welding joint of a second exemplary embodiment; and

FIG. 3 is a diagram to explain a start end portion, a finishing end portion, and a side portion of a second bead.

### DESCRIPTION OF EMBODIMENTS

### First Exemplary Embodiment

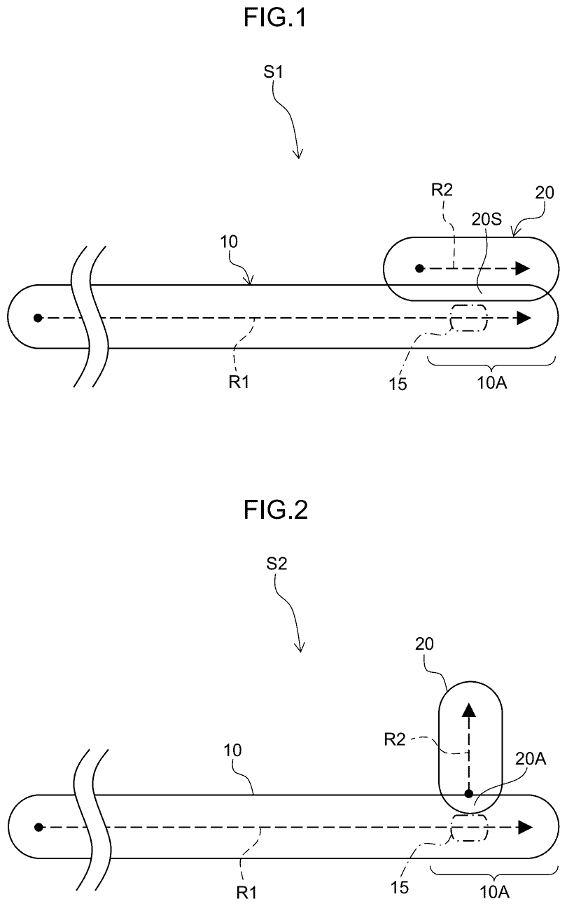

Description follows regarding a laser welding method and a laser welding joint S1 according to a first exemplary embodiment of the present invention, with reference to FIG. 1.

FIG. 1 is a schematic plan view illustrating a laser welding joint S1 fabricated with the laser welding method of the first exemplary embodiment (as viewed from a direction perpendicular to an upper sheet).

The laser welding joint S1 includes a first bead 10 and a second bead 20. The laser welding joint S1 is, for example, a lap joint, but may be a penetration T-joint, or another type of joint.

The laser welding method includes a first irradiation process, a movement process, and a second irradiation process.

First Irradiation Process

The first irradiation process is a process in which a laser is irradiated along a first path R1 so as to form a first bead 10.

The first path R1 is a path having, for example, a straight line shape as illustrated, however, there is no limitation thereto and a curved path may be employed therefor. Laser irradiation in the first irradiation process is performed under conditions in which at least an upper sheet is penetrated, joining the upper sheet and a lower sheet together.

Movement Process

The movement process is a process in which a laser sight is moved from a finishing point of the first path R1 to a starting point of a second path R2, without irradiation by the laser. Note that in the arrows indicating the first path R1 and the second path R2 in the drawings, a black circle portion indicates a starting point, and an arrow head portion indicates a finishing point.

The movement process of the present exemplary embodiment is configured from a width direction movement process and a reverse direction movement process.

The width direction movement process is a process to move the laser sight in a width direction. Reference here to the width direction means a bead width direction at a finishing end region 10A of the first bead 10.

The reverse direction movement process is a process to move the laser sight in a reverse direction. Reference here to the reverse direction means a direction along the finishing end region 10A of the first bead 10 in the opposite direction to the scanning direction in the first irradiation process.

In the present exemplary embodiment the reverse direction movement process is performed following the width direction movement process. However, the width direction movement process may be performed following the reverse direction movement process.

Second Irradiation Process

The second irradiation process is a process in which a laser is irradiated along the second path R2 so as to form a second bead 20.

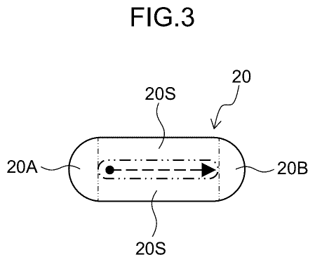

In the present exemplary embodiment, the second path R2 is positioned so as to be displaced in the width direction with respect to a finishing point area of the first path R1, and is a path parallel to the finishing point area of the first path R1. Molten metal from laser irradiation flows in a reverse direction to the scanning direction and perpendicular directions thereto. This accordingly enables an indentation in the finishing end region 10A of the first bead 10 to be filled by molten metal that flows in a direction perpendicular to the scanning direction, from out of the molten metal from the second irradiation process. As a result of performing the second irradiation process in this manner, as illustrated in FIG. 1, a side portion 20S of the second bead 20 (see FIG. 3) becomes in an overlapping state with the finishing end region 10A of the first bead 10.

The starting point of the second path R2 is a position backtracked from a position corresponding to an indentation 15 formed in the finishing end region 10A of the first bead 10. This thereby enables the indentation 15 to be filled appropriately by the molten metal that has flowed in a direction perpendicular to the scanning direction. The position of the indentation 15 may be a position where the indentation 15 is expected to occur, or may be a position where the indentation 15 has been detected using a sensor or the like.

The second irradiation process is preferably performed under conditions in which only the upper sheet is melted, and the lower sheet is not melted. This is because the second irradiation process is a process whose main objective is to fill the indentation 15 formed in the finishing end region 10A of the first bead 10 using the flow of molten metal from the second irradiation process.

The second bead 20 is formed to treat the finishing end region 10A of the first bead 10, and so a length of the second path R2 is shorter than that of the first path R1. The length of the second path R2 is not particularly limited, and may, for example, be from 2 mm to 3 mm.

### Operation and Advantageous Effects

Next, description follows regarding the operation and advantageous effects of the present exemplary embodiment.

In the present exemplary embodiment the laser welding joint S1 includes the first bead 10 formed along the first path R1 and the second bead 20 formed along the second path R2.

The second bead 20 is formed such that the side portion 20S of the second bead 20 overlaps with the finishing end region 10A of the first bead 10. Molten metal from laser irradiation has the property of flowing in a direction perpendicular to the scanning direction or a reverse direction thereto, and so this enables the indentation 15 formed in the finishing end region 10A of the first bead 10 to be filled by the second irradiation process by forming the second bead in this manner.

Moreover, the starting point of the second path R2 is a position different to the finishing point of the first path R1. Namely, after temporarily stopping laser irradiation at the finishing point of the first path R1, the laser irradiation is restarted from a different position to the finishing point of the first path R1 (at the starting point of the second path R2), with this enabling excessive heat input due to turning back to be suppressed, thereby enabling an indentation to be suppressed from developing.

Moreover, in the present exemplary embodiment the second bead 20 extends in a direction parallel to the finishing end region 10A of the first bead 10. The side portion 20S of the second bead 20 overlaps with the finishing end region 10A of the first bead 10.

Due to molten metal not only flowing in the reverse direction to the scanning direction, but also in directions perpendicular thereto, forming the second bead 20 in this manner enables hole filling to be performed.

Moreover, in the present exemplary embodiment the scanning direction of the second path R2 is a direction toward the side of the finishing point of the first path R1. This accordingly enables a more even heat input state at the overlapping portion between the first path R1 and the second path R2 than in an embodiment in which the scanning direction of the second path R2 is a direction toward the side of the starting point of the first path, with this enabling control so as to achieve the same weld cross-section at the overlapping portion.

Moreover, in the present exemplary embodiment the second bead 20 is formed under conditions in which only the upper sheet is melted and the lower sheet is not melted. This enables burn-through or the like from laser irradiation to form the second bead 20 (laser irradiation in the second irradiation process) to be prevented from occurring.

### Second Exemplary Embodiment

Next, description follows regarding a laser welding method and a laser welding joint S2 according to according to the second exemplary embodiment of the present invention, with reference to FIG. 2.

FIG. 2 is a schematic plan view illustrating a laser welding joint S2 fabricated by the laser welding method of the second exemplary embodiment (as viewed from a direction perpendicular to an upper sheet).

The laser welding joint S2 of the second exemplary embodiment is, by including a first bead 10 and a second bead 20, similar to that of the first exemplary embodiment, however it differs from the first exemplary embodiment mainly in the configuration of the second bead 20.

The laser welding method of the second exemplary embodiment is similar to that of the first exemplary embodiment in that it includes a first irradiation process, a movement process, and a second irradiation process, however it differs from the first exemplary embodiment mainly in the second irradiation process.

In the second exemplary embodiment a second path R2 in the second irradiation process is a path having a starting point at a position displaced in the width direction with respect to the finishing point area of the first path R1, and is a path perpendicular to the finishing point area of the first path R1. Molten metal from laser irradiation flows in the reverse direction to the laser progression direction and in directions perpendicular thereto. This means that an indentation at the finishing end region 10A of the first bead 10 can be filled using molten metal that flows in the reverse direction to the scanning direction, from out of the molten metal from the second irradiation process. As a result of performing the second irradiation process in this manner, as illustrated in FIG. 1, a start end portion 20A (see FIG. 3) of the second bead 20 becomes in a state overlapping with the finishing end region 10A of the first bead 10.

A starting point of the second path R2 is a position backtracked to a position corresponding to an indentation 15 formed in the finishing end region 10A of the first bead 10. This accordingly enables the indentation 15 to be filled appropriately by the molten metal flowing in the reverse direction to the scanning direction.

### Operation and Advantageous Effects

In the laser welding joint S2 of the second exemplary embodiment, the second bead 20 extends in a direction perpendicular to the finishing end region 10A of the first bead 10. The start end portion 20A of the second bead overlaps with the finishing end region 10A of the first bead.

The direction of flow of molten metal is mainly the reverse direction to the scanning direction, and so this enables more effective hole filling to be performed that in the first exemplary embodiment.

Supplementary Explanation

Although exemplary embodiments of the present invention have been described, the present invention is not limited to these exemplary embodiments. The following supplementary explanation gives some examples of other possible embodiments.

As the laser welding method in the above exemplary embodiments a method was described in which two sheets, an upper sheet and a lower sheet, were joined. However, the laser welding method of the present disclosure is not limited thereto, and may be a method for joining three or more sheets together.

In the above exemplary embodiments the movement process has been described for an example configured from the width direction movement process and the reverse direction movement process. However, the movement process of the present disclosure is not limited thereto, and may be a process in which the laser sight is moved, for example, in a direction inclined to both the width direction and the reverse direction.

The first exemplary embodiment described above was described for an example in which the scanning direction of the second irradiation process is a direction toward the finishing point side of the first path R1, however the scanning direction of the second irradiation process of the present disclosure may be the opposite direction thereto. Namely, the relationship between the starting point and the finishing point of the second path R2 may be reversed.

Note that there are no particular limitations to a sheet thickness of sheet members being joined by the laser welding method of the present invention. However, the present invention is able to suppress a fall in join strength caused by indentation at a finishing end region of a weld bead, and so may be employed to weld thin sheets together (with, for example, a sheet thickness of 2.0 mm or less, or moreover with a sheet thickness of 1.2 mm or less).

### EXPLANATION OF REFERENCE NUMERALS

S1, S2 laser welding joint
10 first bead
10A finishing end region
20 second bead
20A start end portion
20S side portion
R1 first path
R2 second path

1. A laser welding joint comprising:
a first bead formed along a first path; and
a second bead formed along a second path, wherein a side portion or a starting end portion of the second bead is formed so as to overlap with a finishing end region of the first bead, and a starting point of the second path is at a position different to a finishing point of the first path.

2. The laser welding joint of claim 1, wherein:
the second bead extends in a direction substantially perpendicular to the finishing end region of the first bead; and
the starting end portion of the second bead overlaps with the finishing end region of the first bead.

3. The laser welding joint of claim 1, wherein:
the second bead extends in a direction substantially parallel to the finishing end region of the first bead; and
the side portion of the second bead overlaps with the finishing end region of the first bead.

4. The laser welding joint of claim 3, wherein a scanning direction of the second path is a direction toward a side of the finishing point of the first path.

5. The laser welding joint of claim 1, wherein the second bead is formed under a condition in which only an upper sheet is melted and a lower sheet is not melted.

6. A laser welding method comprising:
a first irradiation process in which a laser is irradiated along a first path to form a first bead;
a movement process in which a laser sight is moved from a finishing point of the first path to a starting point of a second path without laser irradiation; and
a second irradiation process in which a laser is irradiated along the second path to form a second bead, wherein the second irradiation process is performed such that molten metal from the second irradiation process flows toward a finishing end region of the first bead.
